(19) United States
(12) Patent Application Publication
(10) Pub. No.: US 2010/0202071 A1
(43) Pub. Date: Aug. 12, 2010

(54) DEFORMABLE MIRROR

(75) Inventors: André PREUMONT, Chastre (BE); Gonçalo Rodrigues, Bruxelles (BE)

Correspondence Address: MERCHANT & GOULD PC, P.O. BOX 2903, MINNEAPOLIS, MN, 55402-0903, US

(73) Assignee: Universite Libre de Bruxelles, Bruxelles (BE)

(21) Appl. No.: 12/685,386

(22) Filed: Jan. 11, 2010

Related U.S. Application Data
(63) Continuation-in-part of application No. PCT/EP2008/059077, filed on Jul. 11, 2008.
(60) Provisional application No. 60/983,357, filed on Oct. 29, 2007.
(60) Provisional application No. 60/949,136, filed on Jul. 11, 2007.

(30) Foreign Application Priority Data
Nov. 2, 2007 (EP) 07119932.7

(51) Int. Cl. G02B 7/185; B23P 17/04

(52) U.S. Cl. 359/849; 29/428

(57) ABSTRACT

The present invention is related to a deformable mirror comprising individual units (1), each unit including a continuous reflective substrate (2) having a front and back surface, on the back surface of the substrate: a continuous mass electrode (3) and a plurality of in-plane actuators (4) of electrostrictive or piezo-electric material, arranged between the mass electrode (3) and individual addressing electrodes (5).

### FIELD OF THE INVENTION

The present invention is related to the field of space telescopes, large terrestrial telescopes and adaptive optics.

The present invention is particularly related to deformable mirrors used in astronomy.

The present invention is also related to a method to fabricate such deformable mirrors.

### STATE OF THE ART

In astronomy, the larger the size of the primary mirror of a telescope, the finer the details of a scientific target that can be resolved. However, continuous mirrors with a diameter greater than 8 m constitute a real challenge to produce, especially to polish, and are impossible to transport via the present road or rail network. The solution found was to build very large primary mirrors out of independent segments. The Keck and the SALT telescopes, with diameters in the order of 10 m constitute the most successful implementations of this concept. The relative position and orientation between these segments is controlled in three rigid body degrees of freedom: piston, tip and tilt. Furthermore, their radius of curvature can be manually corrected by means of a warping harness in order to compensate for creep and manufacture surface errors. These segments need to be polished with a paraboloid shape in order to properly focalize the incoming light into a single point, with the added difficulty that segments at different positions need to be polished to different shapes. This uniqueness of reflecting shape makes the production and the polishing of the segments an important aspect in the development and construction of future very large telescopes. An alternative approach passes by the creation of spherical instead of parabolic reflecting surfaces which would uniformize the shape to be polished in each segment, but this has the consequence of degrading the beam focalization and complicates the optical system subsequent to the primary mirror.

An additional challenge faced by large telescopes is that the disturbances introduced by the atmosphere become increasingly important as the size of the telescope primary mirror increases. This fact calls for an image correction step introduced by deformable mirrors prior to image formation and constitutes one of the domains of application of adaptive optics.

Adaptive optics consists of employing deformable mirrors for the correction of light wavefronts and has demonstrated success in astronomy, opthalmology, laser beam collimation for industrial and scientific applications and telecommunications.

The first deformable mirrors used in astronomy consisted of a continuous reflecting layer, deformed by linear actuators. This type of actuation exhibits, even today, advantages in terms of a high stroke and temporal and spatial frequency of actuation. However, this concept presents an inherent high complexity and thus an insufficient reliability, and high manufacturing and maintenance costs.

On the other hand, the benefits resulting from the simplicity of the unimorph/bimorph concept of actuation have been praised since the late 1970's and the attempts for its introduction in adaptive optics systems have followed since then. The first successful implementation took place in 1994.

The degree of complexity of the shapes generated depends on the pattern of electrodes defined on the back of the active layer. An example of a layout according to the State of the Art as described in particular in FIG. 1a. Said layout is especially suited for compensating atmospheric turbulence inside a circular aperture while the honeycomb layout provides a homogeneous pattern in which localized circular geometries can be repeated over the aperture and fractally scaled (FIG. 1b).

U.S. Pat. No. 7,019,888 B1 of Mar. 28, 2006 is describing the utilization of an insulating layer for shielding the electrodes and traces from each other and from external electrical fields. It is considered that the layer of active material is shielded by the electrodes.

WO 2004/057407 of Jul. 8, 2004, A1 is describing several configurations of hybrid deformable mirrors which simultaneously employ the bimorph and linear actuation principles. It proposes indeed the utilization of linear actuators for inducing the tilt of the mirrors and one of the configurations presented has all the elements that compose the device within the foot-print of the reflecting surface.

EP0793120 A1 of Sep. 3, 1997 is describing a particular design of a bimorph deformable mirror with enhanced sensitivity which is achieved by employing multiple layers of active materials. One important aspect is the utilization of an elastic sealant layer which has the main aim of rigidifying the structure during polishing in order to facilitate this operation.

US 2005/0088734 A1 of Apr. 28, 2005 is describing a method for assembling a primary mirror of limitless size constituted by segment modules. It focuses mostly on the aspects of feasibility of space transportation and automatic assembling rather than those of reducing the production efforts by taking advantage of mass production methods.

U.S. Pat. No. 4,484,798 of Nov. 27, 1984 is related to a manufacture procedure for rigid segments focusing on the deposition of reflective layers on concave substrates.

US 2006/0221473 A1, of Oct. 5, 2006 is describing a complex design of a segment support structure for controlling the negative impact that the deformations of such a support structure of a segmented mirror have on the alignment and position of these segments. These deformations occur in response to changes in gravity direction, wind loads and thermal gradients.

The development of bimorph mirrors has overcome numerous challenges, including the production of active layers of brittle materials with high aspect ratios, the gluing of these layers to the optical substrates, with the subsequent distortion of the optical surface, the wiring of the independent electrodes to the voltage amplification electronics which was very time consuming, degraded the optical quality and required a significant volume on the back of the mirror. At present, the challenges posed to bimorph technology deal with the increase of spatial and temporal frequency capabilities. An increase in the number of actuators calls for the possibility of segmentation of the aperture into several mirrors. The increase of temporal frequencies will probably pass by the introduction of compliant back structures like those proposed by BAE (document “Planet-finder class zonal bimorph deformable mirror”—presentation to the 1^{st} coordination meeting of an adaptive optics proposal(s) as part of framework program 7, Institute d'Astrophysique de Paris, 29^{th} and 30 Mar. 2006) or damping foams.

The existing studies for the conceptual design of the future TMT (Thirty Meter Telescope) have considered almost hexagonal segments with a straight-to-straight distance of about 1 m and a constant inter-segment gap of 2 to 4 mm. This is illustrated in the document “Development of the primary mirror segment support assemblies for the Thirty Meter Telescope” (PONSLET, E. et al, Optomechanical Technologies for Astronomy, edited by Atad-Ettedgui, Eli; Antebi, Joseph; Lemke, Dietrich, Proceedings of the Society of Photo-Optical Instrumentation Engineers (SPIE), Volume 6273, pp. 627319 (July 2006). p. So far, these constraints have imposed the design of 123 different geometrics with a slightly irregular hexagonal shape which cannot be mass produced.

Document US20060050419 is related to an integrated wavefront correction module and discloses a deformable mirror built from a number of such modules. In each module, a high spatial and temporal frequency correction system is present, consisting of an array of vertical actuators which extend from a support structure to the reflective surface and can elongate or contract in a direction perpendicular to the reflective surface. A tip-tilt correction system is equally disclosed for each module which consists of linear actuators that extend from a second support structure constituting thus a second stage of actuation.

The document “The James Webb Space Telescope” by Gardner et al, Space Science Reviews, volume 123, no 4, April 2006 (published by Springer), describes the design of the 6.6 m aperture space telescope to be launched in the early next decade. It will comprise a lightweight composite deployable structure supporting 18 hexagonal segments with 1.32 m flat-to-flat. This allows such a large aperture to fit inside the fairing of the Ariane 5 launch vehicle. The rotations, translations and the radius of curvature of each segment are actively controlled in order to compensate the surface errors stemming from fabrication, deployment, thermal gradients and ageing. These segments are constituted of beryllium, are a few dozens of millimetres thick but are micromachined as an isogrid in order to become lower weight.

### AIMS OF THE INVENTION

The present invention aims to suggest a device and a method for fabricating such device which can be used as deformable mirror in particular in the field of astronomy which do not have the drawbacks of the state of the art.

### Main Characteristics of the Present Invention

The present invention is related to a mirror as disclosed in the appended claims. The invention is thus related to a deformable mirror comprising individual units or segments, each unit comprising a continuous reflective substrate having a front and back surface, a continuous mass electrode and preferably a continuous dielectric layer on the back surface of said substrate. The unit comprises a number of horizontal, i.e. in-plane actuators, made of an electrostrictive or piezo-electric material and located between the mass electrode and individual addressing electrodes. The actuators may be embedded in said dielectric layer. The reflective substrate can for example be a semiconductor substrate or a glass substrate. According to the preferred embodiment, each unit further comprises extra vertical linear actuators, arranged to produce tip/tilt and piston movement to the reflective substrate. The invention is equally related to a method of fabricating a mirror of the invention and to a method of producing a mirror unit according to the invention. Further preferred embodiments are described by combinations of the independent claims with one or more claims dependent thereon.

### SHORT DESCRIPTION OF THE DRAWINGS

FIG. 1a is describing an example of electrode layout with increasing level of complexity according to the state of the art. FIG. 1b illustrates the honeycomb electrode layout.

FIG. 2 is describing the principle of unimorph/bimorph actuation. The thicknesses of the layers are exaggerated with relation to the in-plane dimension of the mirror. Moreover, the active layer can be continuous or discontinuous.

FIG. 3 is describing the cross-section view of a mirror unit according to the invention. All the elements lie within the foot-print of the reflecting area.

FIG. 4 shows an example of a mirror consisting of 7 hexagonal mirror units, according to the invention.

FIG. 5 shows a preferred embodiment of the device of the present invention wherein shape memory material being e.g. thermally expandable polymer is used in order to give the appropriate curvature to the mirror.

FIG. 6 shows an embodiment, wherein a metal layer is present on the front surface of the mirror unit.

FIG. 7 illustrates an embodiment wherein inflatable cavity structures filled with foam are present on the back of the mirror units.

FIG. 8 is describing the production steps of the screen-printing of the deformable mirror. From upper left to down right: screen-printing of common mass electrode, screen-printing of PZT actuators, PZT actuators after sintering, screen-printing of addressing electrodes. The size, shape and number of individual PZT actuators is adjusted to the particular application by proper sizing of the mask used through which the PZT paste and electrode material are screen printed. In this way, throughout all the steps of the production process all the actuators are dealt with simultaneously, and the effort and time of production is thus independent from the number of actuators. Forming thousands of actuators is as simple as less than a dozen. Screen-printing allows the production of actuators with a minimum size of 3 to 5 mm.

FIG. 9 is describing a fractal tessellation of large reflecting surface from a molecule of 7 hexagons arranged as a honeycomb.

FIG. 10 is describing a cross-sectional view of a honeycomb sub-assembly constituted by 7 individual mirror units.

FIG. 11 is describing a simultaneous application of modal control and fractal zonal control for correcting errors with different wavelengths.

FIG. 12 shows an example of a mirror consisting of 7 hexagonal mirror units, according to the invention, interfacing a telescope flexible support structure by means of a hexapod mechanism.

FIG. 13 illustrates an embodiment of a mirror according to the invention, and the method of producing such a mirror, involving a pre-shaped foam attached to the mirror.

FIG. 14 shows a base template usable for gluing in-plane actuators to a mirror to obtain a mirror according to the invention.

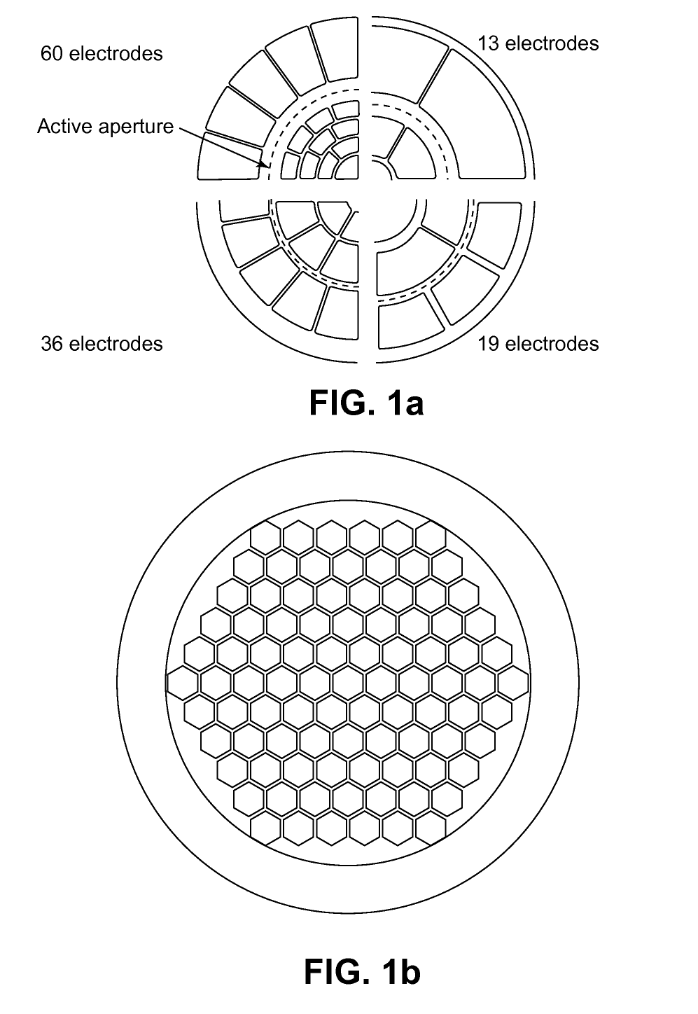

### DESCRIPTION OF A PREFERRED EMBODIMENT OF THE INVENTION

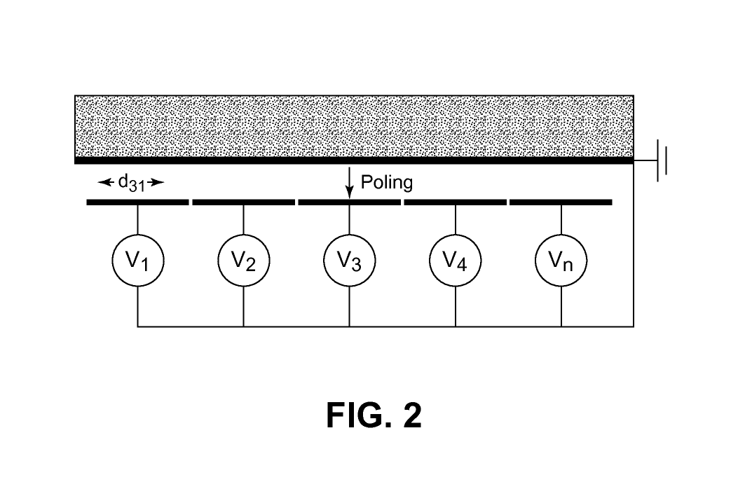

According to FIG. 2, the principle of in-plane unimorph/bimorph actuation consists of having one or more active layers solidary with a passive substrate. According to some authors, the term ‘bimorph’ relates only to the case where two active layers are present, while ‘unimorph’ relates to the case with only one active layer attached to one passive substrate. According to other authors, ‘bimorph’ also includes the latter version with one active layer and one passive substrate. In the context of the present description, both types of actuators can be used, as well as actuators with more than two active layers. All these types will be denominated in the context of this description by the term “in-plane actuators”. An electrical field applied across the active layer and parallel to the direction of polarization induces a transversal localized elongation, i.e. in the direction of the plane of the actuator. The magnitude of this transversal elongation depends on the intensity of the applied electrical field and on the piezo-electric coefficient d₃₁. Displacement compatibility at the interface to the substrate results in an out-of-plane bending deformation. As stated above, in the context of this description, this type of actuator will also be referred to as an in-plane actuator, as opposed to the vertical actuators disclosed for example in US20060050419.

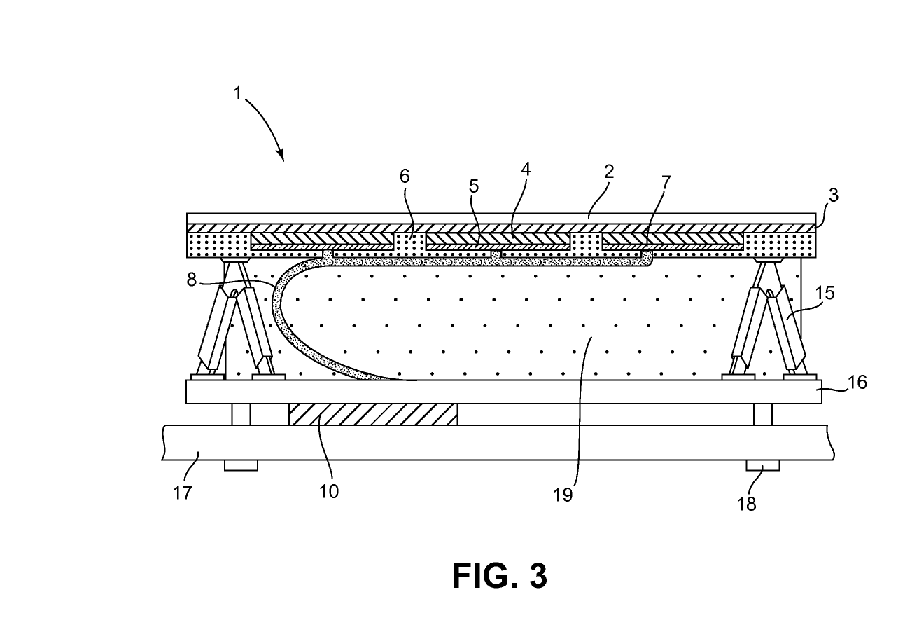

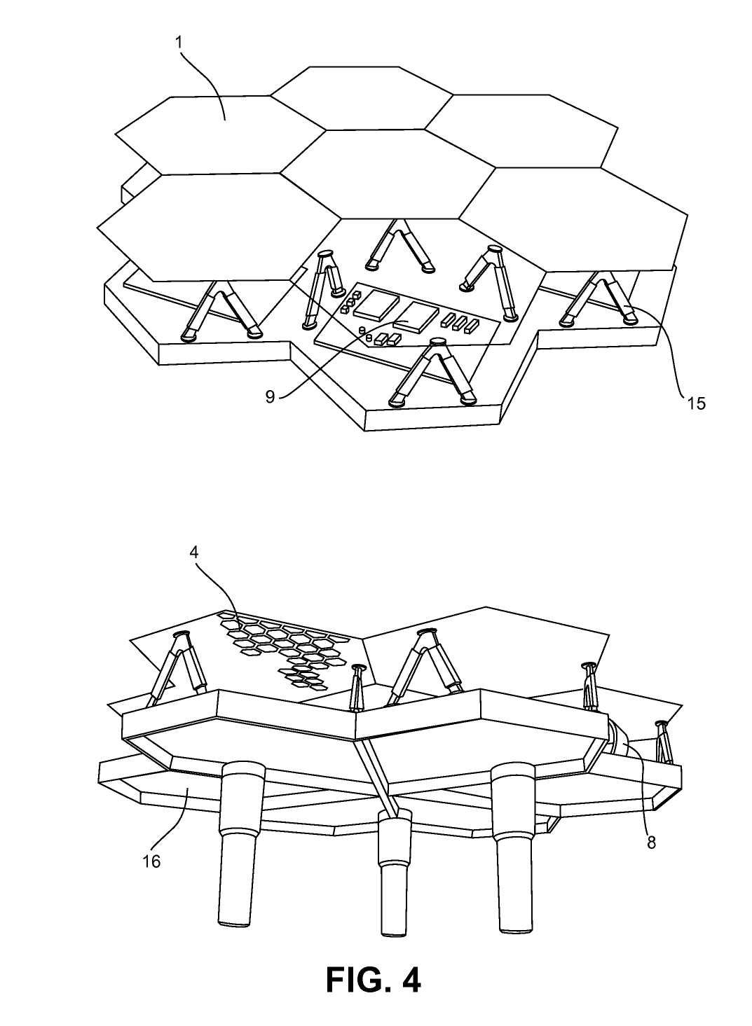

A schematic view of deformable mirror unit 1 according to a preferred embodiment of the invention is shown in FIG. 3. A mirror of the invention comprises a plurality of such units, preferably mutually identical units formed in a regular array. An example of a mirror consisting of 7 hexagon shaped units 1 arranged in a honeycomb pattern is shown in FIG. 4. A mirror may consist of several groups of 7 units to form a large-surface mirror. The invention is characterized by a modular mirror as shown in FIG. 4, i.e. composed from a plurality of preferably identical mirror units, wherein each unit comprises a plurality of in-plane actuators working according to the abovementioned unimorph/bimorph principle. The shape of the units may be hexagonal or otherwise.

Turning back to FIG. 3, the mirror unit 1 as such is now described in detail. Features shown in the drawings and described hereafter are not necessarily limiting to the scope of the present invention. Said scope is only defined by the appended claims. ‘Front’ and ‘back’ are used in the context of this description to refer respectively to the side of the mirror which receives incoming light, and the opposite side thereof.

The mirror unit of FIG. 3 comprises a reflective substrate 2, which can be a semiconductor or a glass substrate. On the back surface of the substrate, a continuous mass electrode 3 is provided, e.g. a Au electrode, and in contact with said electrode, a number of electrostrictive or piezo-electric unimorph/bimorph actuators 4, formed in this embodiment of separate regions of electrostrictive or piezo-electric material. All the actuators in the array are preferably applied simultaneously which makes the deposition process to a large extent independent from the complexity of the array. Addressing electrodes 5 are arranged on the back surface of said actuators, one electrode for each actuator. Said actuators and the addressing electrodes are embedded in a dielectric layer 6. The addressing electrodes are connected by connectors 7, which pass through holes in the dielectric layer, to a flexi-circuit 8, connected to a voltage amplification circuit 9 (see FIG. 4), arranged within the footprint of the mirror unit. An electronic connector 10 is present to connect the unit to external data and power sources. The circuit 9 comprises control electronic means as known in the art, for controlling the actuators and thereby the actuator-controlled deformation of the reflective substrate. Preferably, the circuit 9 comprises high voltage amplifiers. In FIG. 4 it can be seen that the actuators 4 may have a hexagonal shape. However, within the scope of the present invention the shape of the actuators 4 is not limited to a hexagonal shape: the actuators may be hexagonal or otherwise. Moreover, the actuator layout is not limited to a honeycomb. The actuators 4 may be arranged as a honeycomb or otherwise. Also the shape of the individual unit 1 may have any suitable shape, other than the hexagonal shape shown in the drawings.

According to an embodiment, in stead of the separate regions of active material 4, a continuous electrostrictive or piezo-electric layer is provided between the mass electrode and an plurality of addressing electrodes. In this case, it can still be said that a plurality of actuators is present, defined by the position of the addressing electrodes on the surface of the continuous active layer (the ‘actuator’ is then the part of the continuous active layer which is contacted by an addressing electrode).

Each mirror unit is preferably equipped with a set of linear piezo-electric or electrostrictive vertical actuators 15, arranged to actuate a piston, tip and tilt movement of the mirror unit, with respect to a holder structure 16, which is in turn attached to the telescope structure 17 via precision screws 18. With ‘vertical’ is meant that the elongation/contraction of these actuators takes place in a direction perpendicular to the substrate surface or at least not parallel to the substrate surface. Piston, tip and tilt actuations are required to properly align and co-phase the segments in order to smooth the shapes generated by the assembly of deformable mirrors. The piston/tip/tilt actuators may consist of the active bipod kinematic mounts illustrated in FIG. 4. These mounts are very compliant in the in-plane radial directions mitigating out-of-plane deformations of the optical surface resulting from thermal variations. These mounts can also provide vertical actuation following the inclusion of active elements along their legs.

A damping layer 19, preferably consisting of a visco-elastic foam, may be present in the space between the holder and the dielectric layer. This damping layer is applied for reasons of mitigation of the resonant response to actuation and external vibration disturbances.

According to a preferred embodiment of the invention, the mirror unit may be equipped with a means to give a shape with a desired curvature to the reflective substrate, without actuating the horizontal and vertical actuators, i.e. a ‘coarse’ curvature is given to the substrate surface. This coarse deformation is static or has a low frequency of change, and is further finetuned by the action of the actuators 4/15. In this way, the mirror unit of the invention can be produced as a standard product, without requiring polishing steps to produce a desired curvature with high accuracy. This approach allows to produce lighter weight mirror units, which can be produced in a fast and simplified way with respect to existing mirror units.

According to a first embodiment, the coarse curvature is obtained by selecting the materials of the different components (reflective substrate, dielectric layer, horizontal actuators and mass electrode) to have differential thermoelastic distortions. When changing from the temperature of deposition to the temperature of operation, the different layers will undergo differential thermo-elastic distortions resulting in the desired curvature at the temperature of operation.

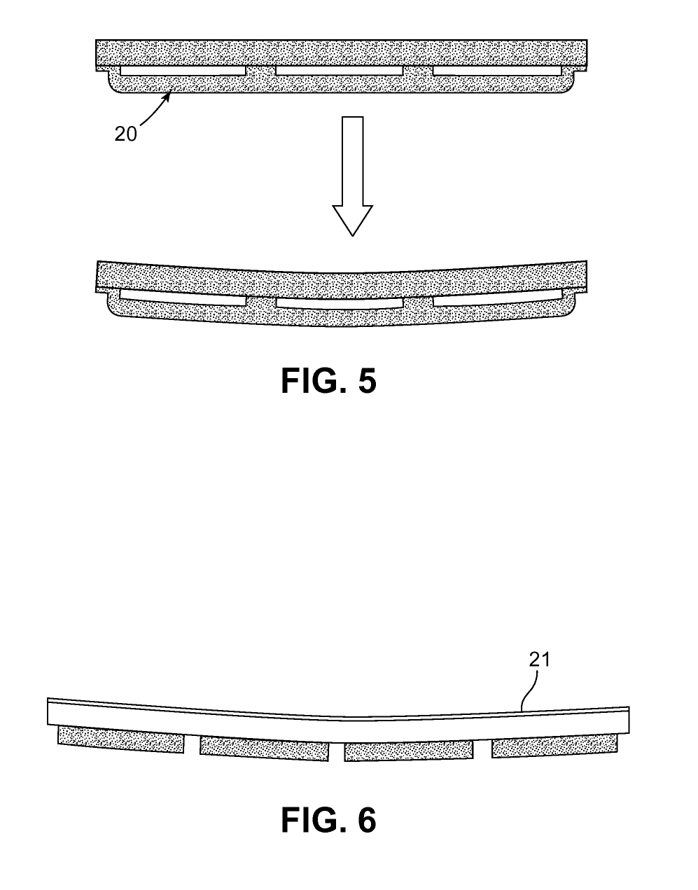

According to a second embodiment, the dielectric layer 6 may be a shape memory polymer layer, as illustrated in FIG. 5. Also, a shape memory polymer layer 20 may be applied in contact with the dielectric layer. The shape memory polymer induces the required curvature following a phase change induced by appropriate heating or cooling.

According to a third embodiment, a metallic coating 21 is applied on the front surface of the reflective substrate, as illustrated in FIG. 6. In this case, the metal layer's surface becomes the reflective surface of the mirror unit. The metal layer can be for example a gold, silver or aluminium layer. In this embodiment, the ‘reflecting substrate’ is formed by the combination substrate/metal layer. The material of the substrate on which the metal layer is deposited may thus be other than a reflecting material. The metal layer introduces a pre-stress on the substrate, resulting in the coarse curvature deformation. Also, the metal may be chosen to obtain a curvature as consequence of differential thermo-elastic distortions (in relation to the deposition temperature) between the metal layer and other components of the unit.

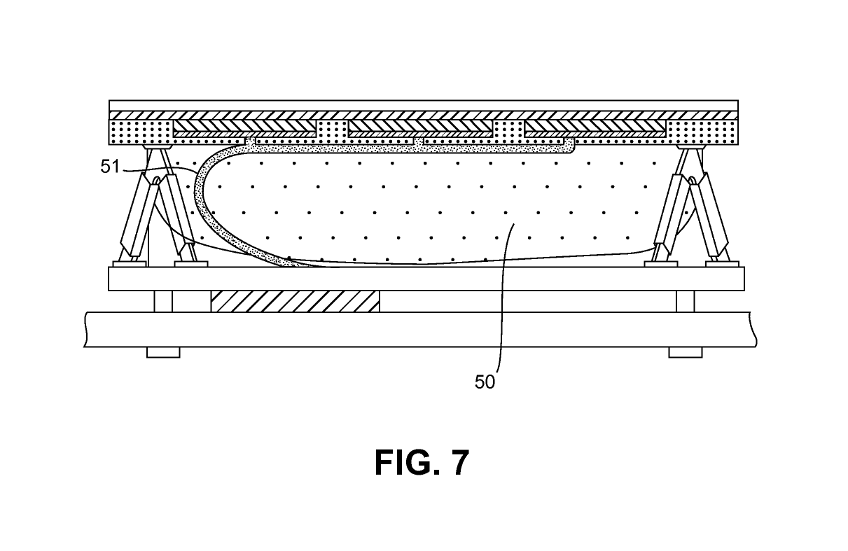

According to a fourth embodiment, the coarse deformation is obtained by introducing a uniform pressure load on the mirror unit, by providing one or more inflatable cavity structures on the backside of the reflective substrate, preferably underneath the dielectric layer. By controlling the pressure inside each of said cavities, the coarse deformation of the reflective surface is controlled. By applying a pressure in the order of a few percent of atmospheric pressure and combining with the piezoelectric correction it is possible to induce a radius of curvature in the order of 10 m and with a precision matching typical optical requirements. FIG. 7 illustrates this embodiment, wherein a single compartment 50 is provided on the back of the mirror. The compartment is obtained by attaching a membrane 51 to the edges of the dielectric layer. Suitable means (not shown) are provided to allow a pressure fluid to be introduced into the cavity or removed therefrom, to thereby regulate the pressure inside the cavity and thus the curvature of the mirror.

According to a further preferred embodiment, compartment 50 is filled with a foam, preferably a visco-elastic foam, which can be inflated or deflated by introduction or removal of a fluid into the pores of the foam and enables the application of pressures below the atmospheric pressure (thereby obtaining a deformation of the substrate by suction). This provides a combined means for vibration, resonant response mitigation to actuation and curvature control.

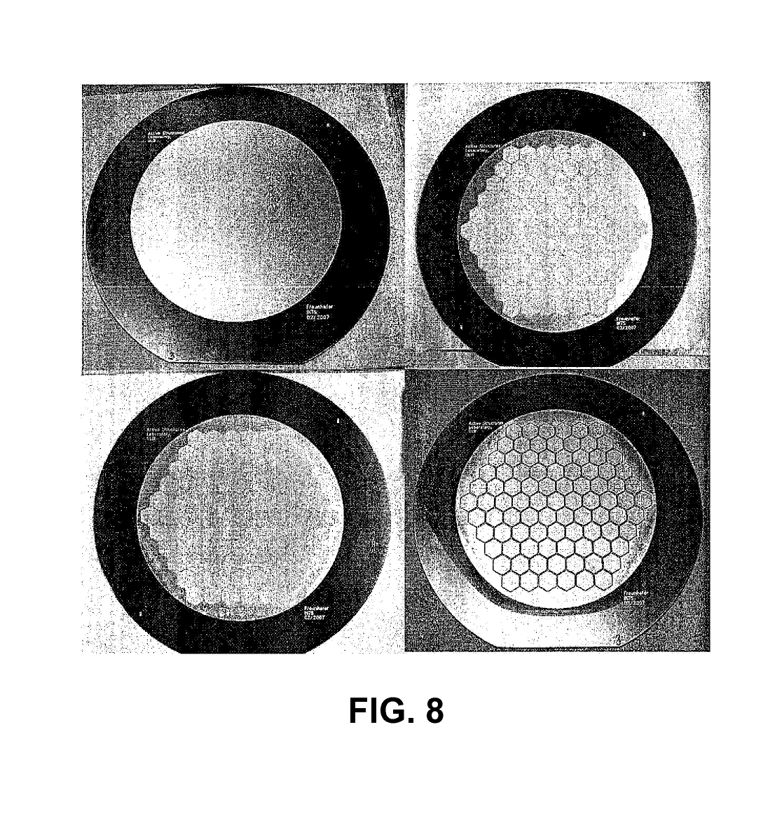

The deformable mirror proposed according to a preferred embodiment consists of a Si wafer commercially available about 600-750 μm thick for wafers with a diameter of 150 mm and which might be thicker for larger diameters. The wafers are covered at the back with a PZT honeycomb actuator array, about 80 μm thick but which can be thicker or thinner (other electrostrictive materials like PMN could also be employed). It has been produced by the Division of Ceramic Technology of the Fraunhofer Institute (IKTS) employing a technique called Screen Printing. First of all, a thin layer of gold, about 10 μm thick, is deposited on the back of the wafer in order to form a continuous mass electrode (similarly, a layer of other high conductive material could also be employed instead). Then, a mask with the shape of the intended actuator layout is placed over the gold electrode, and the PZT layer is deposited adhering to the mirror at the holes of the mask. The set is then placed inside an oven for sintering the piezoelectric actuators. After the sintering step, the individual addressing electrodes are finally deposited on the top of the PZT actuators. Each of these phases is depicted in FIG. 8. Preferably, a SiO2 layer is applied to the back of the silicon wafer, to prevent a reaction of the gold electrode with the Si. The SiO2 is thus present between the silicon wafer and the gold electrode.

The connection of the independent electrodes at the back of the mirror to the voltage amplification electronic circuit comprises two main components as illustrated in FIG. 3:

(a) A layer 6 of an insulating material, like epoxy or another polymer, with a low dielectric constant with little holes at the locations of the center of the addressing electrodes.
(b) A Flex-circuit 8 connecting the little holes to the electric connectors 10 at the back of the mirror and further on to the voltage amplifiers of the control electronics 9.

The back of the mirror is provided with a layer 19 of viscoelastic material, or other high damping flexible material like Sorbothane to damp the flexible modes of the mirror without restricting the quasi-static flexible deformations as described in the FIG. 3.

The mirror is supported at 3 points by linear vertical actuators 15 constituted of PZT or other electrostrictive material, with typical strokes in the order of 50 μm, and which take care of the tip-tilt and piston deformations.

The mirror, plus its PZT 4 and electrode 5 array plus the flexi-circuit 8 plus the visco-elastic layer 19 plus the PZT linear vertical actuators 15, plus the control electronics 9, plus the electric connectors 10 form a unit 1 fully contained within the foot-print of the mirror and ready to be assembled on the supporting structure.

The unit may contain 91 electrodes distributed in a honeycomb array over a hexagonal region with a width of 10 cm making it suitable for applications in existing adaptive optics system, or it may contain from 91 to 2600 electrodes distributed in a honeycomb array over a hexagonal region with a width of 15 to 30 cm, compatible with existing Si wafers.

The silicon wafer shall undergo a precision cutting following or not the boundaries of the honeycomb pattern of actuators in order to allow minimum gaps between each unit when an assembly of several units is formed.

The unit consists typically of a flat mirror (when the coarse curvature means is not present or not active) but might also be a curved mirror, obtained with or without a polishing step, by the coarse curvature described above, in combination with the actuated deformation

If the thermal expansion coefficients of the dielectric layer and the passive substrate are judiciously selected it is possible to skip the polishing step. Following a correct choice of materials, even if the mirror is produced with a plane surface, the two layers will undergo a differential thermoelastic distortion into a spherical one during operation, due to the difference of temperature during these two phases.

Shape memory polymers as described in FIG. 5 constitute an alternative to differential thermoelastic distortion for the obtention of a spherical shape, or another coarse high curvature shape. Preference will be given to solutions that minimize thermoelastic sensitivity at the temperatures of operation. Another possibility would be to immediately apply a shape memory polymer material on the back of the reflective semi-conductor substrate and before applying the continuous electrodes and the actuators.

A conic shape may also be obtained by active means, i.e. further finetuned with respect to the coarse curvature. In the case of a spherical shape, it can be obtained by applying a constant voltage on the electrodes. Typically, a radius of curvature of 60 m is achieved with a constant voltage near 10 V. Here, one must take care of the hysteresis of the PZT under voltage excitation. If a curvature sensor is available, the constant voltage may be controlled in closed-loop. Another alternative is to control the PZT in charge, which considerably reduces hysteresis. If the curved shape is obtained via curvature control of the flat mirror, a full telescope might be built by the assembly of flat mirrors almost uniformly distributed over a paraboloid.

Whether spherical or flat, the units may be used as building blocks for various mirrors of a telescope, including the primary mirror of a large telescope of about 30 m. Simulations have shown that it is possible to uniformly distribute units with constant shape with about Δ=10 cm diameter over the surface of a sphere and maintaining an average gap between segments δ below 1 mm. This configuration results on a parameter δ/Δ in the order of 0.0134 and a Strehl ratio in the order of S=0.95. The gap between segments, δ, accounts for different contributions stemming from the distribution of the segments over a spherical surface, the manufacturing tolerances and the thermal expansion.

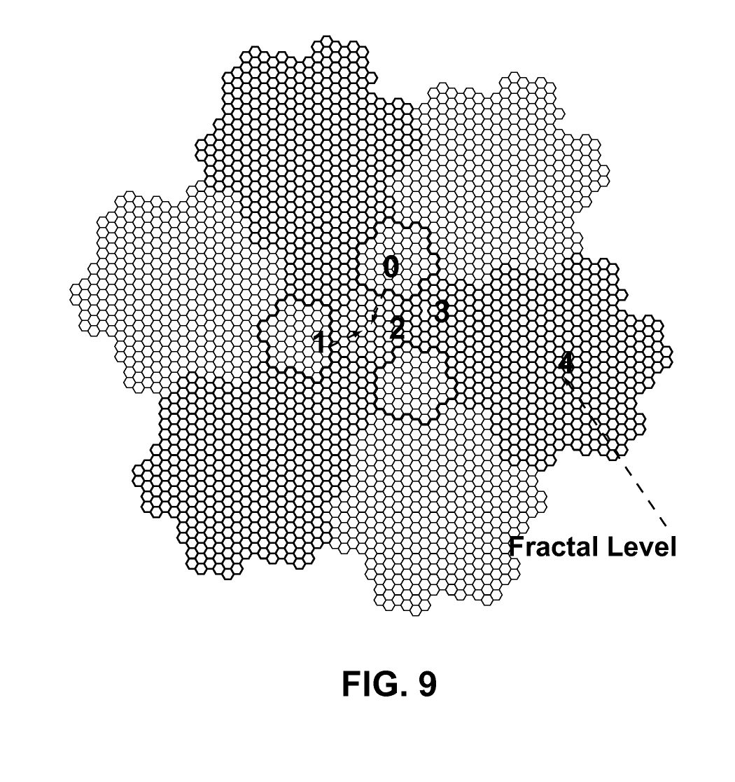

Such a large reflecting surface can be tessellated by fractally repeating a simple molecule constituted by 7 hexagons arranged in a regular honeycomb as it is illustrated in FIG. 9. A 30 m diameter telescope would require about 81600 mirrors measuring 10 cm straight-to-straight or 12200 mirrors measuring 26 cm straight-to-straight. The number of degrees-of-freedom to be controlled amounts to the hundreds of thousands or millions.

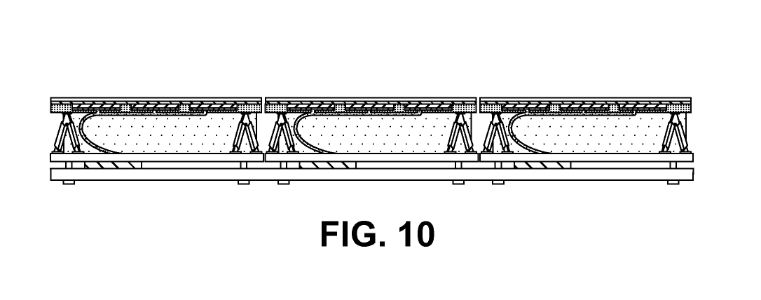

The complexity of assembling such a high number of mirrors can be reduced if these are grouped in honeycomb sets of 7 of these mirrors as illustrated in FIG. 10. This sub-assembling considerably facilitates the transportation of the mirrors and the final assembly of the primary mirrors. A primary mirror with a 30 m aperture would only require about 1000 such sub-assemblies, which is in the order of the number of segments in the conventional designs of the future TMT and E-ELT.

Future adaptive optics systems will require the control of tens of thousands of degrees of freedom for compensating the effects of atmospheric turbulence on very large apertures. Maintaining the shape of very large segmented primary mirrors also requires the control of at least several thousands of degrees-of-freedom. Neither case, however, can be achieved by implementing classical centralized control approaches.

An alternative for controlling such large systems passes by applying hierarchical approaches that divide the active aperture in different sub-domains and performs the simultaneous but independent shape control of these domains according to the same control law. The size of each sub-domain can then be increased, but still applying the same control law, to correct the errors of lower spatial frequency following a fractal pattern.

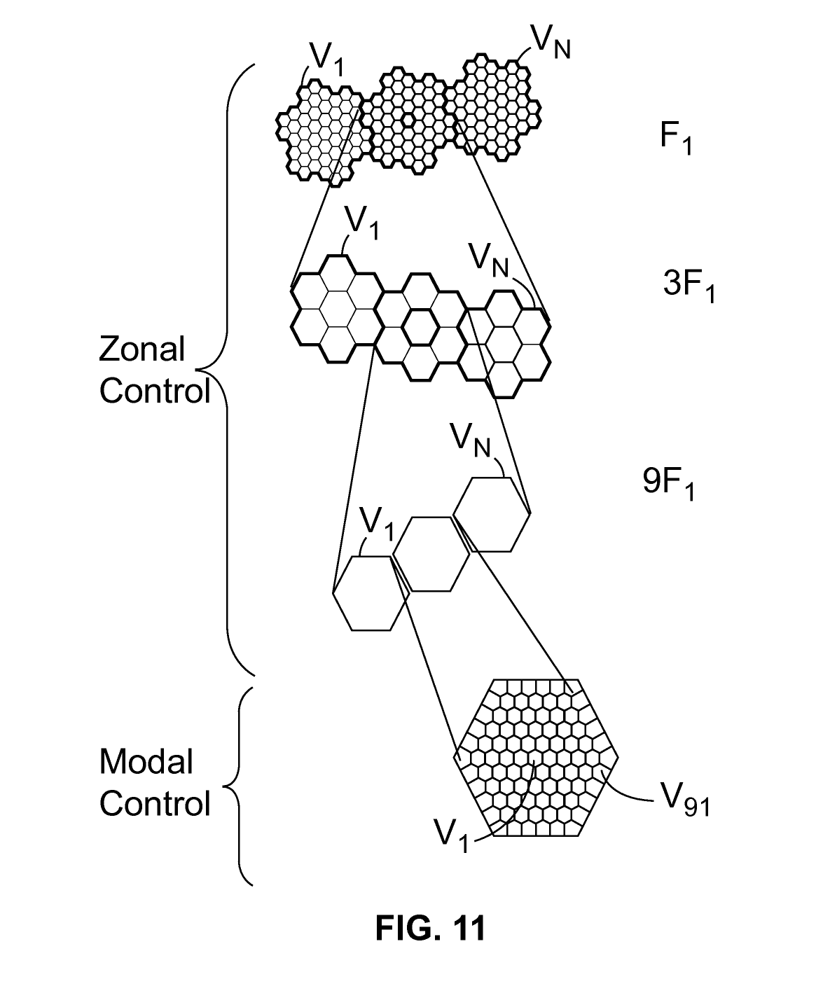

The mechanical decoupling existing between each unit of the bimorph mirror presented herein makes the implementation of such distributed control strategies straightforward. The domains of increasing size can be defined by fractally repeating in circular molecule of 7 hexagons according to FIG. 11. The control of each segment can however be performed globally within the segment by applying classical modal approaches.

The concept of the present invention consists of the utilization of multiple, preferably identical unimorph/bimorph deformable mirrors as elemental modules for generating larger and more complex segmented active reflecting systems.

The cross-section of the proposed elemental module is depicted in FIG. 3. A single such module already has corrective capabilities on its own that make it suitable to equip adaptive optics systems of current astronomical observatories.

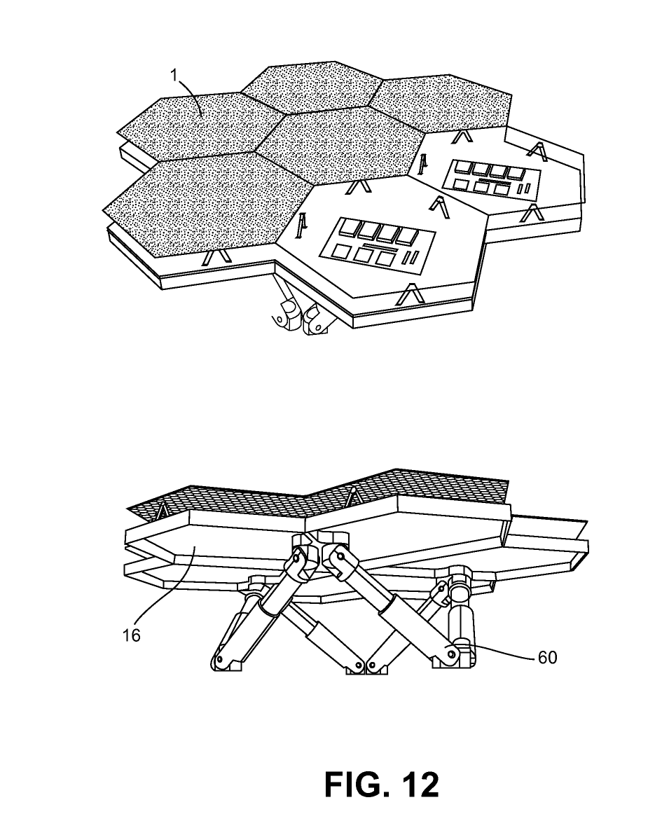

A first application envisioned for this concept consists of employing several units of the type described above, for assembling a segmented deformable mirror with correction capabilities of up to tens of thousands degrees of freedom or more. This configuration will be capable of compensating in real-time the atmospheric induced distortions in future extremely large telescopes like the TMT or the European Extremely Large Telescope, E-ELT. Observations performed with such a telescope with 30 m diameter will require on a first phase the correction of about 5000 degrees-of-freedom. This capability of correction can be achieved by employing 49 individual mirrors forming two levels of fractal distribution of a single mirror as in FIG. 9 and would result in a deformable mirror with about 70 cm diameter. Unimorph and bimorph mirrors produced by screen-printing are extremely light-weight and for instance, the proposed embodiment has an estimated surfacic density in the order of 6 to 10 kg/m². It is thus extremely advantageous when applied as a deformable mirror supported by light-weight structures like secondary deformable mirrors, M2, or the deformable mirror M4 of the E-ELT. FIG. 12 illustrates a possible embodiment in which a deformable segmented mirror as proposed in this invention is utilized as a secondary deformable mirror M2 or as a deformable mirror M4 and interfaces the telescope support structure by means of a hexapod mechanism, 60. Control-structure interaction is very significantly mitigated when deformable mirrors are very light-weight. Therefore, the interaction with other control systems of the telescope like the primary mirror, optical delay lines, tip-tilt mirrors and other deformable mirrors as well as the production of vibrations that degrade the image on other components of the telescope will be enormously reduced. Moreover, screen-printing is an extremely simple process of depositing actuators. By spraying the in-plane actuators through a mask, the complexity and the time of production become independent of the number of actuators. This fact, together with the more compact, simple and robust configuration of the unimorph/bimorph in-plane actuators becomes a critical advantage when correcting many thousands of degrees-of-freedom in comparison with devices in which the optical surface is deformed by linear actuators. Finally, the fact that high-voltage amplifiers are part of the module makes the multiplication of modules to form the assembly straightforward avoiding the additional installation of components for electrical conditioning. Deformable mirrors with this degree of correction will also find application in domains other than astronomy such as systems employing lasers for scientific, industrial or military applications.

Another example of the concept proposed herein is the assembly of the primary mirrors of the future extremely large telescopes from the identical units of the type described above. Simulations have shown that it is possible to tessellate a spherical mirror with identical elements with inter-segment gaps small enough to prevent the introduction of distortions. The nominal curvature required for each component in order to generate the global primary mirror shape can be obtained by design, by adequately matching the thermoelastic coefficients of the substrate, electrostrictive and dielectric layers in order to produce a spherical shape without requiring a complex polishing process. During operation, active correction of the surface, enables both the disturbance rejection from wind and thermal gravity gradients and also the generation of a parabolic shaped surface which is different for every segment radial position. The active control of such a parabolic shape is considerably facilitated by the imposed nominal spherical shape.

This approach enables the assembly of extremely large primary mirrors from exactly identical components that can be mass-produced, and skips the steps of dedicated polishing of different curved surfaces for each segment. Means for sensing the adequate co-phasing and alignment between segments need to be envisaged and will probably consist of optical sensors based on Hartmann test and or edge sensors.

Another example of application of the proposed embodiment is in space telescopes, in which weight is the most important factor in the selection of a structure. Actively controlled segmented unimorph/bimorph deformable mirrors with a surfacic density of 6 kg/m2 have the potential for outperforming the current technology of passive and monolithic space telescope reflectors or segmented telescope mirrors with thick segments and controlled in 7 degrees-of-freedom.

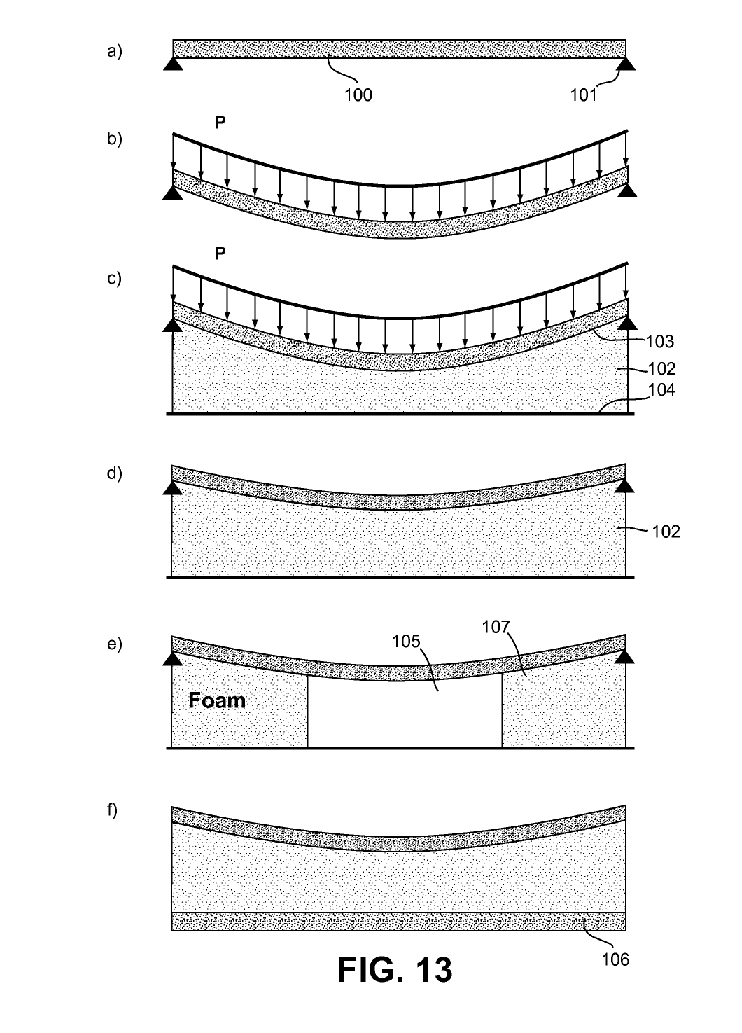

FIG. 13 illustrates another embodiment according to the invention, of a pre-formed mirror unit having a coarse curvature, without actuating the actuators. In this embodiment, the coarse curvature is obtained through the attachment of the mirror to a pre-formed piece of foam.

This pre-formed mirror is produced according to the process steps illustrated in FIG. 13 a to f. First an active mirror 100 is provided. This may be a mirror as shown in FIG. 3, i.e. provided with a plurality of in-plane actuators, e.g. PZT actuators. The mirror is horizontally mounted so as to be supported on its edges by suitable support means 101 (FIG. 13a).

A load P is applied to the mirror so as to deform (bend) the mirror (FIG. 13b). According to a first embodiment, the deformation is elastic, i.e. the deformation is reversible when the load is removed. However, the load may also be such as to give a plastic (non-reversible) deformation to the mirror. The load P may be a uniform load, for example applied by a pneumatic force in a suitable installation.

A piece of foam 102 is provided having a front surface 103 and a back surface 104. According to the preferred embodiment, the foam material is such that the foam exhibits essentially no creep and retains its shape over time. The foam is pre-shaped so that the front surface 103 matches the shape of the bent mirror (FIG. 13c). The back surface 104 opposite to the pre-shaped surface preferably remains flat. The pre-shaped surface may correspond to the whole of the mirror surface as shown in the drawing, or to a portion thereof. The foam may be pre-shaped by a known machining technique. The pre-shaped foam is then glued to the bent mirror.

Then the load P is removed. During this release, the foam tensions the mirror, so that the mirror does not return to its non-deformed state but remains in a deformed state different from the initial flat shape and the shape under the load P (FIG. 13d).

The final shape of the mirror can be adjusted to the desired prescription by appropriately tuning several design parameters. These are the pressure P applied to the mirror, the region of contact between the foam and the mirror and the distribution of the equivalent modulus of elasticity of the foam which can be tuned by producing holes 105, 107 (FIG. 13e). Holes 105 may be provided through the complete thickness of the foam 102. Alternatively, holes may be provide through a part of the thickness of the foam, or holes 107 may be produced according to a pattern.

The final assembly can be made thermally stable by gluing the base of the foam to a mirror 106 identical to the one utilized on the optical side (FIG. 13f), in a sandwich configuration. The mirror 106 on the backside acts as a dummy mirror.

In an alternative to screen-printing, the mirror of the invention can be fabricated by gluing the in-plane actuator array to a reflective substrate, e.g. a silicon wafer. The gluing of previously sintered PZT in-plane actuators (hereafter also called patches) avoids the extremely high strains that arise between these patches and the silicon wafer during sintering and the resulting warping of the mirror. This warping is characterized by an intense permanent curvature and the print-through of the different actuators on the optical surface of the mirror. Furthermore, the possibility of applying the actuator patches by gluing makes it possible or easier to apply actuator patches thicker than those that can be screen-printed and of substrates other than silicon wafers.

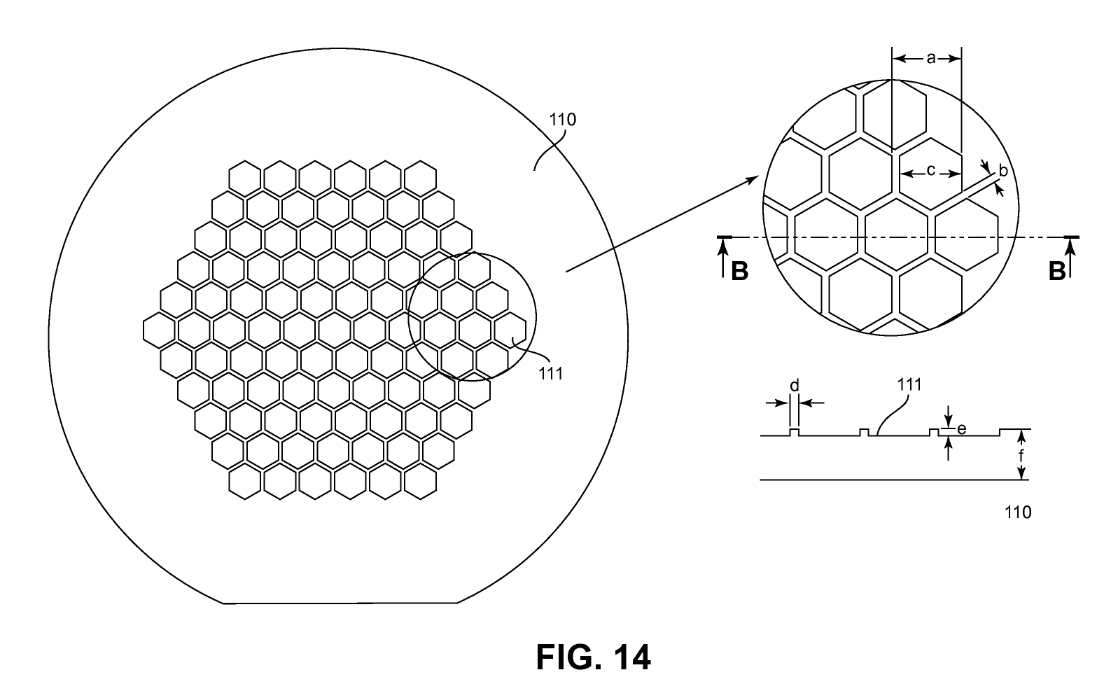

One way to glue the actuator patches within a short period of time is to use the template base depicted in FIG. 14. The template base is a substrate 110 with a pattern of cavities 111 provided on one surface, said pattern corresponding to the pattern of in-plane actuators on the mirror, e.g. the honeycomb pattern described above and also used as an example in FIG. 14. The pattern of the actuator patches is excavated (drilled, etched or other) in the surface of a base substrate so that cavities are produced in the base substrate's surface, with planar dimensions so as to be able to receive an actuator into each cavity, and with a depth slightly lower than the thickness of the actuators. For example, 150 μm deep cavities can be used for gluing actuators which are 200 μm thick. The dimensions indicated in FIG. 14 may have the following values, by way of example only: a=9.08 mm; b=0.48 mm; c=8.6 mm; d=0.48 mm; e=150 μm; f=10 mm. It is to be noted that the detail that shows the depth d the cavities is not drawn to scale.

The production process can then consist of the following:
1) The (e.g. PZT) in-plane actuators are produced (e.g. by a suitable dicing technique) and sintered independently and an individual electrode is applied on one side of each actuator,
2) Each actuator is positioned inside of each cavity of the template base with the individual electrodes in contact with the bottom of the cavity,
3) A common continuous electrode is applied on the back side of the substrate, e.g. a 10 micron gold layer as described above,
4) The substrate is glued to the actuators by gluing the common electrode to the actuators positioned on the template. The substrate may be positioned by a suitable positioning tool onto the base template, and glued by a suitable adhesive material,
5) The substrate/actuators assembly is removed from the template.

The final configuration is identical to the screen-printed mirrors previously described. According to an embodiment, the template base is coated with a suitable release film, such as a Teflon® film, to facilitate the final removal of the entire mirror once the gluing is completed.

As an alternative to the utilization of a template base, other means for automatically gluing the patches can be considered such as with robotic means.

1. A deformable mirror comprising individual units, each unit comprising:
a continuous reflective substrate having a front and back surface,
on the back surface of said substrate: a continuous mass electrode and a plurality of in-plane actuators of electrostrictive or piezo-electric material, arranged between said mass electrode and individual addressing electrodes;
wherein each of said units is provided with means for producing a curvature of the reflective substrate, without actuation of said actuators.

2. The mirror according to claim 1, further comprising a dielectric layer on the back surface of said substrate, and wherein said in-plane actuators are embedded in said dielectric layer.

3. The mirror according to claim 1, each unit further comprising extra vertical linear actuators arranged to produce tip/tilt and piston movement to the reflective substrate.

4. The mirror according to claim 1, wherein in each unit all the addressing individual electrodes or part of the addressing individual electrodes are connected through a flexible connection to a voltage amplification electronic circuit.

5. The mirror according to claim 1, each of said units further comprising a damping layer on the back surface of the reflective substrate.

6. The mirror according to claim 1, wherein the material of at least two of the following components:
Reflective substrate,
Dielectric layer,
Horizontal actuators,
Mass electrode,
is chosen so that differential thermo-elastic distortions can be produced between two or more of said components, leading to said curvature.

7. The mirror according to claim 1, wherein said means for producing a curvature comprise a shape memory polymer layer.

8. The mirror according to claim 1, wherein said means for producing a curvature comprise a metal layer present on the front surface of said substrate, said curvature being obtained by pre-stress of the metal layer.

9. The mirror according to claim 1, wherein said means for producing a curvature comprise one or more inflatable cavity structures arranged on the backside of the mirror unit, said structures being arranged to be able to be inflated by introduction of a fluid into said cavities, to produce said curvature.

10. The mirror according to claim 9, wherein said cavity structures are filled with a foam.

11. The mirror according to claim 1, wherein said mirror is attached to a pre-formed piece of foam.

12. The mirror according to claim 11, wherein said piece of foam comprises a hole or a pattern of holes through the piece of foam's thickness.

13. The mirror according to claim 11, further comprising a dummy mirror on the opposite side of said piece of foam.

14. The mirror according to claim 1, wherein each individual unit has the form of a hexagon.

15. The mirror according to claim 11, wherein said units are placed according to a honeycomb array in order to create an assembly of at least seven units.

16. The mirror according to claim 1, wherein in each unit, each individual in-plane actuator has the form of a hexagon.

17. The mirror according to claim 1, wherein said plurality of actuators is formed in a continuous electrostrictive or piezo-electric layer present between said mass electrode and said addressing electrodes.

18. Method to fabricate a mirror according to claim 1, wherein the assembly of individual units are assembled in order to create a honeycomb shape of seven or multiple of seven individual units.

19. Method for producing an individual mirror unit, wherein said mirror unit comprises a plurality of actuators formed by separate regions of electrostrictive or piezo-electric material, and wherein said actuators are deposited simultaneously by screen printing.

20. The method according to claim 19, wherein said individual addressing electrodes are equally deposited simultaneously by screen printing.

21. A method of producing a deformable mirror, comprising the steps of:
Providing a mirror having a continuous reflective substrate having a front surface and a back surface, and on said back surface: a continuous mass electrode and a plurality of in-plane actuators of electrostrictive or piezo-electric material, arranged between said mass electrode and individual addressing electrodes;
Arranging said mirror on support means so as to support the mirror on its edges, the reflective surface being on the opposite side of said support means;
Applying a load onto the reflective surface so as to bend the mirror elastically into a bent shape;
Providing a piece of foam having one surface being pre-formed to correspond with at least a portion of said bent shape;
Attaching said piece of foam to the back side of said mirror, while the mirror is elastically deformed by said load;
Releasing said load, while the mirror remains attached to said piece of foam, so that the mirror remains in a final deformed state.

22. The method according to claim 21, wherein said attaching step comprises gluing the piece of foam to the back side of said mirror.

23. The method according to claim 21, further comprising the step of producing a hole or a pattern of holes in said piece of foam in order to tune said final deformed state.

24. The method according to claim 21, further comprising the step of attaching a second mirror to the side of said piece of foam opposite to the side where said first mirror is attached.

25. A method of producing a deformable mirror comprising a continuous reflective substrate having a front and back surface, and on the back surface of said substrate: a continuous mass electrode and a plurality of in-plane actuators of electrostrictive or piezo-electric material, arranged between said mass electrode and individual addressing electrodes, said method comprising the steps of:
Providing a reflective substrate;
Producing a continuous mass electrode on the back surface of said substrate;
Producing a plurality of said in-plane actuators, having addressing electrodes on one side; and
Gluing said actuators to said mass electrode according to a predefined pattern.

26. The method according to claim 25, further comprising providing a base template, the base template being a substrate wherein cavities have been produced in a pattern corresponding to said pattern of the actuators, the planar dimension of each cavity being such as to be able to receive an actuator, the depth of each cavity being smaller than the thickness of the actuators, and wherein the method comprises the steps of:
Placing said actuators into the cavities, said addressing electrodes contacting the bottom of said cavities,
Attaching the reflective substrate to said actuators, by gluing the mass electrode to the actuators while the actuators are positioned in the cavities,
Removing the base template.

27. The method according to claim 26, further comprising the step of coating the base template with a release film, prior to placing the actuators into said cavities.

28. The method according to claim 25, wherein said actuators are glued onto the substrate by robotic means.
